(19) United States
(12) Patent Application Publication
(10) Pub. No.: US 2003/0147791 A1
(43) Pub. Date: Aug. 7, 2003

(54) Multi-stage loop reactor

(76) Inventors: Fuxin Ding, Haidian Distract (CN); Naiju Yuan, Haidian Distract (CN); Zheng Liu, Haidian Distract (CN); An Ma, Xicheng District (CN); Yong Qiao, Xicheng District (CN)

Correspondence Address: Paul E. McGowan, Esq., McGuireWoods LLP, One James Center, 901 East Cary St., Richmond, VA, 23219-4030, US

(21) Appl. No.: 10/323,494

(22) Filed: Dec. 18, 2002

(30) Foreign Application Priority Data
Feb. 1, 2002 (CN) 02 2 02768.8

(51) Int. Cl. B01F 3/00

(52) U.S. Cl. 422/227; 422/231

(57) ABSTRACT

A multi-stage loop reactor, employed in various gas-liquid or gas-liquid-solid chemical reaction systems, which comprises a reactor body, draft tube(s) inside the reactor body, and a gas distributor at the bottom of draft tube. The draft tube can include one or more sections. The multi-stage loop reactor of the present invention has a higher mass transfer rate because the different phases are well mixed throughout the reactor, and the gas bubbles are distributed evenly everywhere. The reactor of this invention can be extensively applied in various gas-liquid or gas-liquid-solid reaction processes including the oxidization process, hydrogenation process, hydrocracking process, coal liquification process, fermentation process, hydrocarbon processing process, and biological treatment of waste water, etc.

### FIELD OF THE INVENTION

The present invention relates to a reactor for various gas-liquid two-phase and gas-liquid-solid three-phase chemical reactions, belonging to the chemical engineering field, specifically to a multi-stage loop reactor.

### BACKGROUND OF THE INVENTION

Currently, gas-liquid or gas-liquid-solid reactors are widely applied in the chemical industry, the petrochemical industry and other industrial processes. Generally, the bubble reactor and stirred tank reactor are adopted in gas-liquid or gas-liquid-solid reactions. These two conventional reactors are less effective, and highly energy-consuming, so their application fields are limited by the reaction systems. In such reaction processes, the important features for these reactors are required in the effective mixing of gas-liquid or gas-liquid-solid materials, uniform distribution of the gas and solid particles in the liquid phase, high flow rate of the liquid along the specified direction and the high mass transfer rate. Particularly, for the reactions in which mass transfer is a controlling step of the overall reaction process, in order to speed up the reaction process, various stirring methods must be used to increase the mass transfer rate and the interphase mixing. Mechanical stirring approaches not only may consume much energy, but also cannot be realized for the high-temperature, high pressure and highly corrosive reaction systems.

The internal loop reactor, developed on the basis of the bubble reactor, introduces a draft tube into the reactor so that the fluid can produce loop flow inside the reactor to enhance the mixing performance of the gas-liquid or gas-liquid-solid materials. The overall mass transfer behavior of the loop reactor is also better than that of the traditional bubble reactor.

The traditional internal loop reactor, however, also possesses a significant drawback, i.e., in the circular region between the draft tube and inner wall of the reactor. Since the buoyancy of a bigger bubble may be greater than the drag force on the bubble, caused by the liquid flow, the bubble cannot be dragged away along with the liquid flow, leading to relatively small gas hold-up in this region, and hence the relatively low overall efficiency of the reactor.

### SUMMARY OF THE INVENTION

A purpose of the present invention is to provide an improved multi-stage loop reactor based on the traditional bubble reactors.

This multi-stage loop reactor adopts multi-stage draft tube and internals of various structures, and has overcome the drawbacks of low gas hold-up in the circular region and low efficiency of the conventional loop reactors. This invention has shown obvious advantages over the traditional loop reactors and bubble reactors in terms of good fluid mechanics performance, improved gas-liquid or gas-liquid-solid mixing, high mass transfer rate, and uniform temperature distribution inside the reactor, and it can be widely applied in various gas-liquid or gas-liquid-solid chemical reactions.

According to an embodiment of the present invention, the multi-stage loop reactor mainly comprises a reactor body, at least one draft tube inside the reactor body, and a gas distributor at the bottom of the reactor. The multistage loop reactor may have 1 to 6 draft tubes, depending on the reactor diameter, which are parallel axially, and each of them is installed with one gas distributor. The bottom of the draft tube is 10 to 100 cm away from the bottom of the reactor; the top of the draft tube is 10 to 200 cm below the surface of the liquid phase.

For the multi-stage loop reactor with one draft tube, the ratio of reactor height to the inner diameter of the reactor is 3-12, and the ratio of the diameter of the draft tube to the inner diameter of the reactor is 0.4-0.9. The draft tube may compose of one or more sections in line with the reactor height. As for the multi-section draft tube, the separation between two sections is 5 to 50 cm, and a number of holes of certain diameter are made in different locations on each section. The sections are connected with rigid strips and the internal is fixed between sections. In case of one section draft tube, a number of holes of certain diameter are made in different locations. The total opening area of the holes is determined on the basis of the length and the inner diameter of the draft tube.

This present invention of multi-stage loop reactor has significant advantages listed as follows:

(1) This invention of multi-stage loop reactor comprises the reactor body, draft tube, internals, and the gas distributor. The draft tube is of one or more sections, and various forms of combination and/or internal components can be used between the sections.

(2) The reaction gas enters the reactor through the gas distributor at the bottom of the reactor. As soon as the gas spurts from the gas distributor, the gas bubbles are formed in the liquid phase, and due to the spurting action and the density difference between bubble area and the neighboring area, the bubble cluster will move upwards with the liquid in the bubble region. This will lead to a quick loop flow of the fluid around the draft tube and each stage, forming a specific flow pattern, i.e., a large loop flow incorporated with small loop flows.

(3) It could be seen that, in this multi-stage loop reactor, the gas-liquid mixing is appropriate, the overall gas hold-up is high, and the local gas hold-up is uniformly distributed throughout the reactor. Therefore, the overall gas-liquid mass transfer rate is high. In addition, for gas-liquid-solid three-phrase reaction systems, the solid particles are distributed evenly throughout the reactor and no local accumulation or sedimentation occurs.

(4) This multi-stage loop reactor is shown to have more efficient heat transfer behavior. Since the fluid moves quickly along the specified direction in the reactor, the heat exchanging rate is higher between the fluid and the inner wall of the reactor; meanwhile, because all the materials are well distributed and mixed inside the reactor, the temperature distribution is uniform inside the reaction system, with little temperature difference from one location to another.

### BRIEF DESCRIPTION OF DRAWINGS

FIG. 1 is a first structure drawing of the multi-stage loop reactor for an embodiment of the present invention, which comprises a reactor body, a draft tube and a gas distributor.

FIG. 2 is a second structure drawing of the multi-stage loop reactor for an embodiment of the present invention, which comprises a reactor body, a draft tube, an internal and a gas distributor.

FIG. 3 is a third structure drawing of the multi-stage loop reactor for an embodiment of the present invention, which comprises a reactor body, a multi-stage draft tube, and a gas distributor.

FIG. 4 is a fourth structure drawing of the multi-stage loop reactor for an embodiment of the present invention, which comprises a reactor body, a multi-stage draft tube, an internal and a gas distributor.

FIG. 5 shows the structure of the internal, which is fixed between the draft tubes for an embodiment of the present invention.

FIG. 6 is a drawing of the fluid flow pattern inside the reactor structure as illustrated in FIG. 1.

FIG. 7 is a drawing of the fluid flow pattern inside the reactor structure as illustrated in FIG. 2.

FIG. 8 is a drawing of the fluid flow pattern inside the reactor structure as illustrated in FIG. 3.

FIG. 9 is a drawing of the fluid flow pattern inside the reactor structure as illustrated in FIG. 4.

FIG. 10 is a drawing of the structure and the fluid flow pattern in an embodiment of the multi-stage and multi-draft tube loop reactor.

### DETAILED DESCRIPTION OF THE INVENTION

The detailed description of an embodiment of this invention is made below with reference to the attached figures.

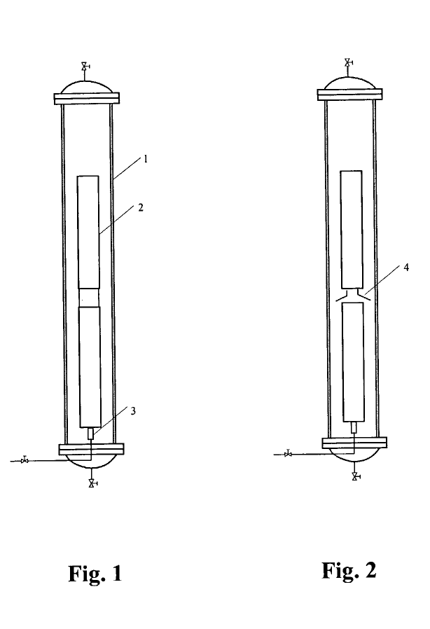

As shown in FIG. 1, the invention comprises three components: the reactor body 1, draft tube 2, and gas distributor 3. The draft tube 2 can be of one section, two sections or more sections, and rigid strips are used to connect these sections.

As shown in FIG. 2, it indicates four components of the reactor, including the reactor body 1, draft tube 2, internal 4 and gas distributor 3. The draft tube 2 can be of one section, two sections or more sections.

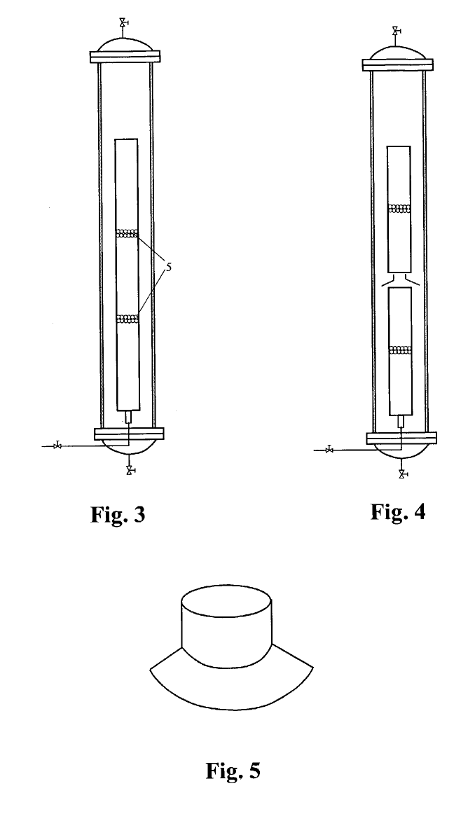

As shown in FIG. 3, it indicates three components of the reactor, including the reactor body 1, the draft tube 2 with holes 5 opened, and the gas distributor 3. The holes 5 can be made along the axial direction at one location, two locations or more locations on the draft tube 2.

As shown in FIG. 4, it indicates four components of the reactor, including the reactor body 1, the draft tube 2, the internal 4, and the gas distributor 3. The draft tube 2 can be of one section, two sections or more sections, and holes 5 are made in different locations of each section on the draft tube 2.

Shown in FIG. 5 is the structure of the internal 4, which is fixed between the draft tubes 2 in an embodiment of the present invention.

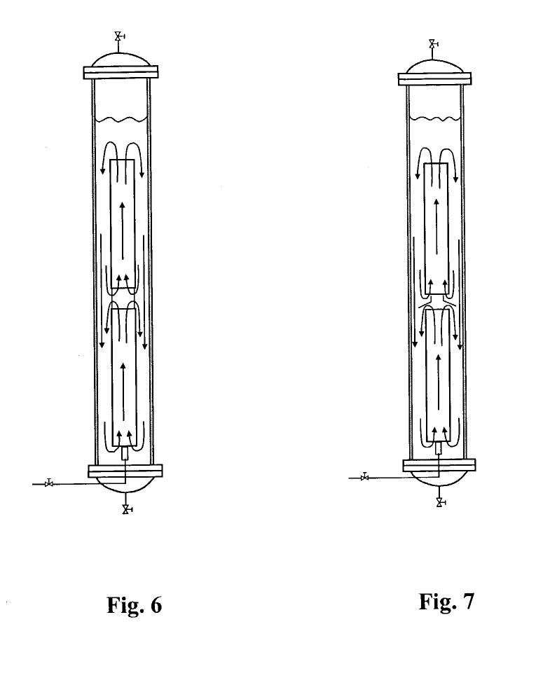

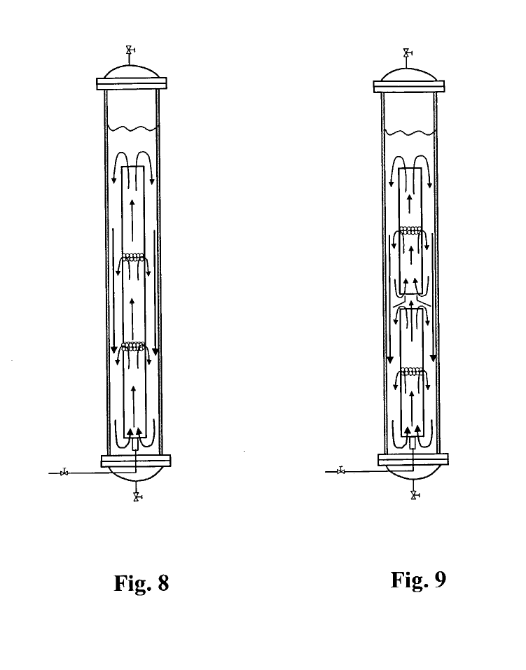

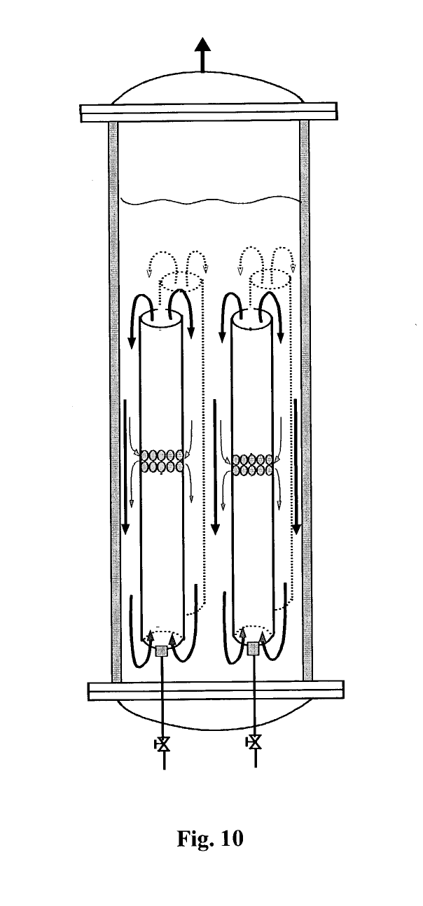

As shown in FIG. 6, the fluid moves fast along a specified direction around the whole draft tube 2 and its individual sections inside the reactor, forming a specific flow pattern, i.e., a large loop flow around the whole draft tube 2 incorporated with small loop flows around each section.

In an embodiment of a multi-stage loop reactor of the present invention, the reaction gas enters the reactor through the gas distributor 3 at the bottom of the reactor, and as soon as the gas spurts from the distributor, a number of gas bubbles are produced around the distributor 3 in the liquid phase, and a dilute phase region is formed. The fluid density in this bubble region is less than that of the surrounding liquid phase, and due to the spurting action and the density difference between the bubble region and the neighboring region, the bubble cluster will move upwards with the adjacent liquid inside the draft tube 2, and then the liquid in the circular region between the draft tube 2 and the internal wall of the reactor will immediately flow to the gas distributor region to make supplement. When the fluid reaches to the top of the first section of the draft tube 2, under the action of the internal and the static pressure difference, a part of the fluid flows to the circular region through the gap between the first and second draft tube 2, and converges with the fluid moving downwards inside the circular region; while a part of the fluid still moves upwards into the second draft tube 2 and keeps the upward movements there, and reaches to the top of the second draft tube 2, and then a part of the fluid will move downwards to the circular region through the section gap, as described before.

Obviously, in the above-described movement inside the reactor, many small loop flows will be formed inside each section of the draft tube 2, and a large loop flow will be also formed along the whole draft tube 2. This will lead to a quick loop flow of the fluid around the draft tube 2 and each stage, forming a specific flow pattern, i.e., a large loop flow incorporated with small loop flows. Therefore, inside the reactor of the present invention, the turbulence extent is not different at different locations, the bubbles are distributed evenly everywhere, the distribution of local gas hold-up is uniform, and for the gas-liquid-solid reaction systems, the solid particles are well dispersed without any significant difference throughout the reactor. Since the gas are taking multi-stage loop movements inside the reactor, its travels a longer distance before it leaves the reactor, the gas-liquid mixing and contacting are enhanced, and therefore, the gas solubility in the liquid phase is higher compared with the conventional bubble reactor at similar operation conditions.

The multi-stage loop reactor of this invention comprises four components, i.e., the reactor body 1, internal 4, draft tube 2 and gas distributor 3. The reactor of this invention does not involve any mechanical stirring parts inside the reactor, and the fluid makes a loop flow along a specified direction inside the reactor, resulting in good gas-liquid or gas-liquid-solid mixing, no dead space, and higher mass transfer rate. Under the action of the draft tube and internal components, the hydrodynamic pattern of large loop flow incorporated with the small loop flow is formed inside the reactor so that the bubbles and the solid particles are distributed uniformly, the distribution of the local gas hold-up and solid-containing are uniform, and solid particles are not accumulated at any location in the reactor. In addition, due to the quick loop flow of fluid in the reactor, the temperature in the reactor is distributed uniformly, with good heat exchanging between the fluid and the inner reactor wall. This invention can be widely applied in various gas-liquid or gas-liquid-solid reaction processes including the chemical oxidization process, hydrogenation process, hydrocracking process, coal liquification process, fermentation process, hydrocarbon processing process, and biological treatment of waste water, etc.

The multi-stage draft tube 2 can be divided two stages, three stages, and more stages according to the height of the reactor. The multi-stage draft tube 2 can be of different forms including the following examples: the draft tube 2 can be divided into many sections, with 5-50 cm space between them, while an internal 4 can be added between the adjacent sections; for each section of the draft tube 2 some holes can be made on different locations of the section, and the number and diameter of the holes are dependent on the length and the diameter of the section. The draft tube 2 can also be of only one section, and some holes are made on the different locations of the draft tube 2; the number and diameter of the holes are dependent on the length and the diameter of the draft tube 2. In the embodiment described herein, the gas distributor 3 is installed at the bottom of the draft tube 2 in the reactor.

The multi-stage loop reactor of the present invention can have several draft tubes 2 and each of them can possess one stage or more stages, as mentioned above. Also, in this embodiment of the present invention, a gas distributor 3 is fixed at the bottom of each draft tube 2.

We claim:

1. A multi-stage loop reactor, comprising:
a reactor body;
at least one draft tube; and
a gas distributor,
in which the draft tubes are located inside the reactor body, and the gas distributor is fixed at the bottom of the draft tube.

2. The multi-stage loop reactor according to claim 1, in which the ratio of the height of the reactor body to the inner diameter of the reactor is 3-12, and the ratio of the diameter of the draft tube to the inner diameter of the reactor is 0.4-0.9.

3. The multi-stage loop reactor according to claim 1, in which the draft tube comprises:
one or more sections, connected with rigid strips;
the separation between the sections is 5 to 50 cm;
an internal is added between the adjacent sections; and
holes can be made on each section of the draft tube.

4. The multi-stage loop reactor according to claim 3, in which the holes are made along the draft tube.

5. The multi-stage loop reactor according to claim 4, in which the holes are made on one or more areas on the draft tube.

6. The multi-stage loop reactor according to claim 1, further comprising an internal component fixed between adjacent sections of the draft tube.

7. The multi-stage loop reactor according to claim 1, in which the bottom of the draft tube is 10-100 cm away from the bottom of the reactor; and
the top of the draft tube is 10-200 cm below a surface of the liquid phase.

8. The multi-stage loop reactor according to claim 1, in which the draft tube has multi-stages and these stages are fixed coaxially allowing a certain distance to remain between each stage.

9. The multi-stage loop reactor according to claim 1, in which 1 to 6 draft tubes are applied,
the draft tubes located parallel axially with certain distance, fixed in the reactor; and
a gas distributor is set on the bottom of each draft tube.
